(19) United States
(12) Patent Application Publication
(10) Pub. No.: US 2025/0219380 A1
(43) Pub. Date: Jul. 3, 2025

(54) WIRE MOVABLE PATH REGULATING COMPONENT AND PATH REGULATING WIRE HARNESS

(71) Applicant: SUMITOMO WIRING SYSTEMS, LTD., Yokkaichi-shi, Mie (JP)

(72) Inventors: Kazuma ISODA, Yokkaichi-shi (JP); Hiroki UNO, Yokkaichi-shi (JP)

(73) Assignee: SUMITOMO WIRING SYSTEMS, LTD., Yokkaichi-shi, Mie (JP)

(21) Appl. No.: 18/848,010

(22) PCT Filed: Mar. 17, 2023
(86) PCT No.: PCT/JP2023/010524

§ 371 Date: Sep. 17, 2024

(30) Foreign Application Priority Data
Mar. 30, 2022 (JP) 2022-054890

(51) Int. Cl. H02G 11/00; B60R 16/02

(52) U.S. Cl. CPC H02G 11/006; B60R 16/0215

(57) ABSTRACT

A wire movable path regulating component for regulating a movable path of at least one first wire and at least one second wire that extend between a first component and a second component movable relative to the first component, the wire movable path regulating component including: a main body configured to be coupled in a rotationally movable manner to another wire movable path regulating component; and a cover that is a separate component from the main body and is attached to the main body.

### BACKGROUND

The present disclosure relates to a wire movable path regulating component and a path regulating wire harness.

JP 2020-141519A discloses a cable guide in which a plurality of tubular link frame bodies disposed in a row are coupled together in such a manner as to be rotatable relative to each other. The link frame bodies each include a main body part and a cover body and are constituted to be tubular in shape. A wire harness is housed in the coupled link frame bodies.

### SUMMARY

For example, the link frame bodies themselves are assumed to be designed in accordance with a basic design for wiring in a vehicle. However, electrical wires may possibly be added after the basic design. It is thus desired to be able to readily handle the case where electrical wires are added to the basic design.

An exemplary aspect of the disclosure is to be able to readily handle addition of electrical wires.

A wire movable path regulating component of the present disclosure is a wire movable path regulating component for regulating a movable path of at least one first wire and at least one second wire that extend between a first component and a second component movable relative to the first component, the wire movable path regulating component including a main body to be coupled in a rotationally movable manner to another wire movable path regulating component, and a cover that is a separate component from the main body and is attached to the main body, the main body having a housing opening through which the at least one first wire is to be housed and a first wire housing space configured to house the at least one first wire in a state of passing therethrough inside the housing opening, the cover having a cover main body that blocks the housing opening and an additional enclosing part forming a second wire housing space that is configured to house the at least one second wire in a state of passing therethrough, the second wire housing space being partitioned from the first wire housing space by the cover main body, and a wire housing slit extending from an opening edge on one side of the second wire housing space to an opening edge on another side of the second wire housing space being formed in the additional enclosing part.

A path regulating wire harness of the present disclosure is a path regulating wire harness including a plurality of the wire movable path regulating component, the at least one first wire, and the at least one second wire, the plurality of wire movable path regulating components being coupled together in a row in such a manner as to be rotationally movable relative to each other, the at least one first wire being housed in the plurality of wire movable path regulating components in a state of passing through the first wire housing space, and the at least one second wire being housed in the plurality of wire movable path regulating components in a state of passing through the second wire housing space.

According to the present disclosure, addition of electrical wires can be readily handled.

### BRIEF DESCRIPTION OF THE DRAWINGS

FIG. 1 is a schematic plan view showing a state in which a path regulating wire harness according to an embodiment is arranged between a vehicle body main body and a sliding door.

FIG. 2 is a perspective view showing part of the path regulating wire harness.

FIG. 3 is a cross-sectional view taken along line III-III in FIG. 2.

FIG. 4 is an exploded perspective view showing a wire movable path regulating component.

FIG. 5 is a cross-sectional view taken along line V-V in FIG. 2 showing the wire movable path regulating component.

FIG. 6 is a plan view showing a cover component.

FIG. 7 is a cross-sectional view showing a cover component according to a modification.

### DETAILED DESCRIPTION OF EMBODIMENTS

### Description of Embodiments of Disclosure

Initially modes of the present disclosure will be enumerated and described.

A wire movable path regulating component of the present disclosure is as follows.

(1) A wire movable path regulating component for regulating a movable path of at least one first wire and at least one second wire that extend between a first component and a second component movable relative to the first component, including a main body component to be coupled in a rotationally movable manner to another wire movable path regulating component, and a cover component that is a separate component from the main body component and is attached to the main body component, the main body component having a housing opening through which the at least one first wire is housed and a first wire housing space for housing the at least one first wire in a state of passing therethrough inside the housing opening, the cover component having a cover main body part that blocks the housing opening and an additional enclosing part forming a second wire housing space for housing the at least one second wire in a state of passing therethrough, the second wire housing space being partitioned from the first wire housing space by the cover main body part, and a wire housing slit extending from an opening edge on one side of the second wire housing space to an opening edge on another side thereof being formed in the additional enclosing part.

According to the present disclosure, even if the second wire is added, the path of the first wire which is based on a basic design is regulated within the first wire housing space. The addition of the second wire is thus unlikely to affect the movement of the first wire. Also, the path of the second wire is regulated within the second wire housing space partitioned from the first wire housing space. The path of the first wire is regulated within the first wire housing space, and, separately thereto, the path of the second wire is regulated within the second wire housing space. Changes in the path lengths of the first wire and the second wire in response to changes in the paths thereof are thus reduced. Variation in the loads acting on the first wire and the second wire is thereby reduced, when the paths of the first wire and the second wire change.

Also, the second wire can be readily housed within the second wire housing space via the wire housing slit.

(2) The wire movable path regulating component according to (1), in which the main body component and the cover component may be made of a fiber reinforced resin. In this case, it becomes possible to secure the strength of the wire movable path regulating component with the main body component and cover component made of a fiber reinforced resin.

(3) The wire movable path regulating component according to (1) or (2), in which the wire housing slit may include a bent portion that bends between the opening edge on the one side of the second wire housing space and the opening edge on the other side thereof. In this case, the wire housing slit includes the bent portion, and thus the second wire housed in the second wire housing space is unlikely to come out through the wire housing slit.

(4) The wire movable path regulating component according to (3), in which the bent portion may bend so as to describe a curve. The second wire is thus unlikely to strongly push against edge portions that bend so as to describe a curve on both sides of the wire housing slit.

(5) The wire movable path regulating component according to any one of (1) to (4), in which an outer width of the wire housing slit may be greater than or equal to a diameter of the second wire. It is thereby easy to insert the second wire into the wire housing slit.

(6) The wire movable path regulating component according to any one of (1) to (5), in which an overall width of the wire housing slit may be greater than or equal to the diameter of the second wire. It is thereby easy to insert the second wire into the wire housing slit.

(7) The wire movable path regulating component according to any one of (1) to (5), in which a minimum width of the wire housing slit may be smaller than the diameter of the second wire. The second wire to thereby unlikely to come out through the wire housing slit.

(8) The wire movable path regulating component according to any one of (1) to (7), in which the wire housing slit may be formed in a widthwise center of the cover component. In this case, even if the left and right sides of a plurality of cover components differ, the second wire can be housed within the second wire housing space through the wire housing slit at a position in the widthwise center of the plurality of cover components.

(9) The wire movable path regulating component according to any one of (1) to (8), in which the main body component may have a locking part located on both sides of the housing opening, the cover main body part may have a lock-receiving part to which the locking part latches, and the additional enclosing part may be located inward of the lock-receiving part. The lock-receiving part can thereby be readily molded.

(10) The wire movable path regulating component according to any one of (1) to (9), in which the at least one second wire housed within the second wire housing space may be fewer in number than the at least one first wire housed within the first wire housing space. In this case, the smaller number of second wires can be readily added.

(11) The wire movable path regulating component according to any one of (1) to (10), in which a length of the additional enclosing part in a through direction of the second wire housing space may gradually decrease proceeding away from the main body component. In this case, when the wire movable path regulating component rotates relative to another wire movable path regulating component, the additional enclosing part is unlikely to interfere with the other wire movable path regulating component.

(12) The wire movable path regulating component according to any one of (1) to (11), in which a portion of the additional enclosing part on an opposite side to the main body component may be formed in an arc shape as viewed in the through direction of the second wire housing space. In this case, it is easy to cover the wire movable path regulating component with an exterior component such as a rubber boot.

Also, a path regulating wire harness according to the present disclosure is as follows.

(13) A path regulating wire harness including the wire movable path regulating component according to any one of (1) to (12), the at least one first wire, and the at least one second wire, the plurality of wire movable path regulating components being coupled together in a row in such a manner as to be rotationally movable relative to each other, the at least one first wire being housed in the plurality of wire movable path regulating components in a state of passing through the first wire housing space, and the at least one second wire being housed in the plurality of wire movable path regulating components in a state of passing through the second wire housing space.

According to this path regulating wire harness, addition of electrical wires can be readily handled, and, in the path regulating wire harness, variation in the loads acting on the first wire and the second wire is reduced, when the paths of the first wire and the second wire change.

### Detailed Description of Embodiments of Disclosure

Specific examples of a wire movable path regulating component and a path regulating wire harness of the present disclosure will be described below with reference to the drawings. Note that the present disclosure is not limited to these illustrative examples and is indicated by the claims, and all changes that come within the meaning and range of equivalency of the claims are intended to be embraced therein.

### Embodiment

Hereinafter, a wire movable path regulating component and a path regulating wire harness according to an embodiment will be described.

### Example Application of Path Regulating Wire Harness

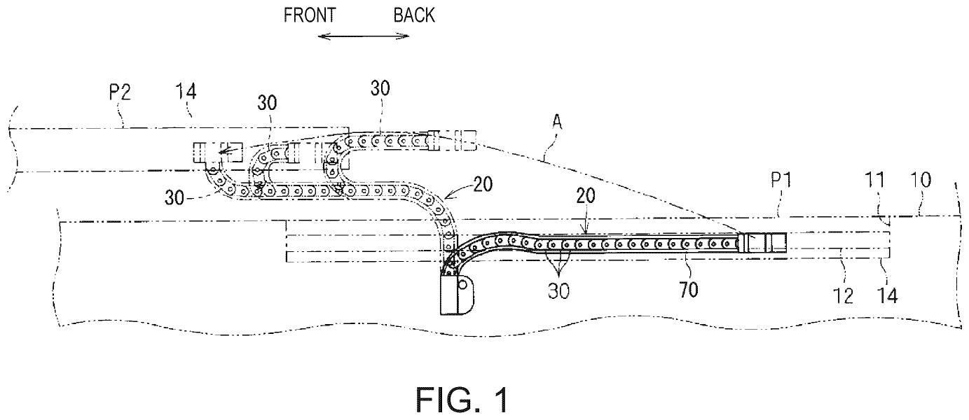

FIG. 1 is a schematic plan view showing a state in which a path regulating wire harness 20 is arranged between a vehicle body main body 10 and a sliding door 14. Note that, in FIG. 1, the path along which the sliding door 14 moves when the sliding door 14 is opened and closed is indicated by an arrow A. Also, the change in the state of the path regulating wire harness 20 with opening and closing of the sliding door 14 is indicated by a two-dot chain line.

The relationship between the vehicle body main body 10 and the sliding door 14 will now be described. A vehicle includes the vehicle body main body 10 and the sliding door 14 provided on one side portion of the vehicle body main body 10. A passenger entrance 11 through which people can get in and out of the vehicle is provided on the one side portion of the vehicle body main body 10. The sliding door 14 is supported in such a manner as to be movable between a position at which the passenger entrance 11 is closed (closed position P1) and a position at which the passenger entrance 11 is open (open position P2), by a slide support mechanism part that includes a guide rail 12 and a movable support part that supports the sliding door 14 in a state of being movable along the guide rail 12. In the present embodiment, the closed position P1 is located rearward of the open position P2.

The sliding door 14 opens and closes the passenger entrance 11 by sliding on the side of the vehicle body main body 10. Here, the sliding door 14 displaces outward in the vehicle width direction (see arrow A) while sliding from the closed position P1 to the open position P2. The vehicle body main body 10 is an example of a first component, and the sliding door 14 is an example of a second component that moves relative to the vehicle body main body 10.

The path regulating wire harness 20 extends between a vehicle body main body 10 and a sliding door 14 such as described above. When the sliding door 14 moves relative to the vehicle body main body 10, the path regulating wire harness 20 moves with the movement of the sliding door 14. The range of movement of the path at this time is regulated by a wire movable path regulating component 30. Interference of the path regulating wire harness 20 with the sliding door 14 or a peripheral portion of the passenger entrance 11 of the vehicle body main body 10 is thereby suppressed.

The first component and the second component between which the path regulating wire harness 20 extends are not limited to the above examples. The path regulating wire harness 20 extends between a first component and a second component that moves relative to the first component. For example, the first component may be a vehicle body (e.g., floor) and the second component may be a sliding seat.

### Regarding Path Regulating Wire Harness

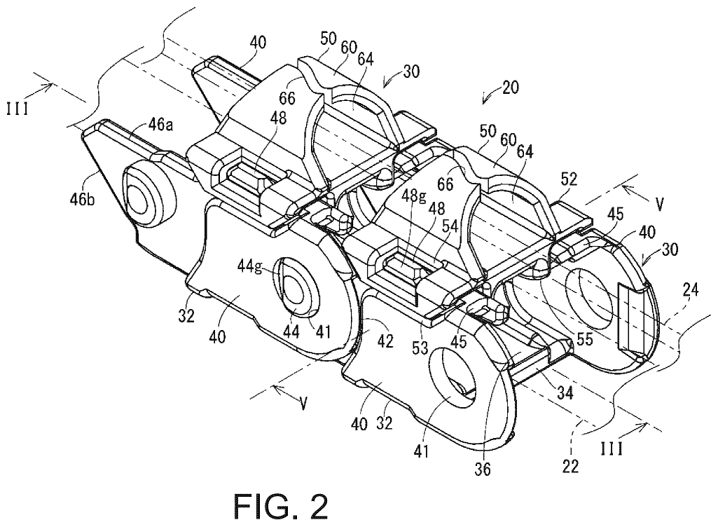

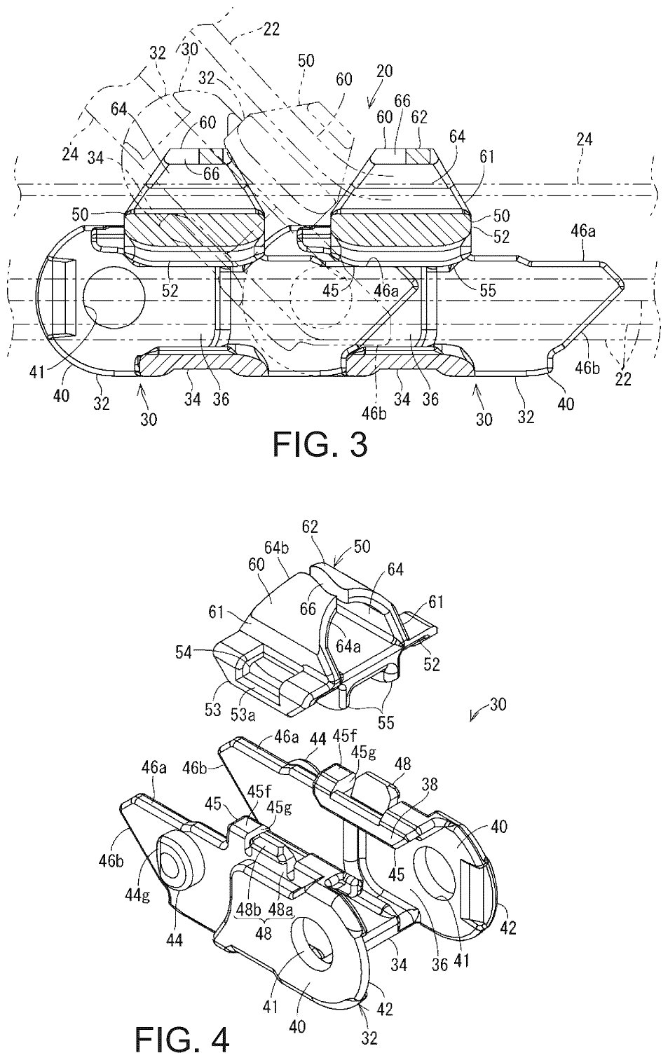

FIG. 2 is a perspective view showing part of the path regulating wire harness 20, and FIG. 3 is a cross-sectional view taken along line III-III in FIG. 2. In FIG. 3, a state in which wire movable path regulating components 30 that are coupled together move rotationally is indicated by two-dot chain lines.

As shown in FIGS. 1 to 3, the path regulating wire harness 20 is provided with a plurality of wire movable path regulating components 30, at least one first wire 22, and at least one second wire 24. A plurality of first wires 22 are shown as one bundle in FIG. 2.

The plurality of wire movable path regulating components 30 are coupled together in a row in such a manner as to be rotationally movable relative to each other. In the present embodiment, adjacent wire movable path regulating components 30 are coupled together in such a manner as to be rotationally movable about one axis. The adjacent wire movable path regulating components 30 are thus restricted from rotationally moving about a different axis from the one axis. As a result of the plurality of wire movable path regulating components 30 being coupled in such a manner as to be rotationally movable about axes parallel to the one axis, the plurality of wire movable path regulating components 30 are coupled so as to be able to bend in one plane, and bending in a direction away from the one plane is inhibited.

Also, the rotational movement range of the adjacent wire movable path regulating components 30 about the one axis is regulated. The bending direction and bending range of the plurality of wire movable path regulating components 30 are thereby regulated in the one plane. The configuration for regulating this rotational movement range will be described later.

The wire movable path regulating components 30 each include a first wire housing space 36 and a second wire housing space 64. The first wire housing space 36 and the second wire housing space 64 are adjacent to each other in a partitioned state.

The first wire 22 is a wiring member that electrically connects an electrical component on the vehicle body main body 10 side with an electrical component on the sliding door 14 side. One first wire 22 or a plurality of first wires 22 may be provided. The second wire 24 is a wiring member that electrically connects an electrical component on the vehicle body main body 10 side with an electrical component on the sliding door 14 side. One second wire 24 or a plurality of second wires 24 may be provided. The first wire 22 has, for example, a core wire 22a and an insulating coating 22b that covers the core wire 22a. The second wire 24 includes, for example, a core wire 24a and an insulating coating 24b that covers the core wire 24a.

The first wire 22 is, for example, envisaged to be a wiring material for connecting installed electrical components at the basic design stage of a vehicle. The second wire 24 is, for example, envisaged to be a wiring material that is connected to an electrical component added due to retrofitting or the like after the basic design stage of the vehicle. The number of second wires 24 is thus envisaged to be fewer than the number of first wires 22.

The first wire 22 is passed through and housed in the respective first wire housing spaces 36 of the plurality of wire movable path regulating components 30 that are arranged successively in a row. The second wire 24 is passed through and housed in the respective second wire housing spaces 64 of the plurality of wire movable path regulating components 30 that are arranged successively in a row. The paths of the first wire 22 and the second wire 24 are thus regulated within the separate spaces 36 and 64 of the plurality of wire movable path regulating components 30, while remaining in parallel.

The first wire 22 and the second wire 24 may be signal cables or power cables. A plurality of first wires 22 may be bundled in the form of a twisted wire or may be bundled in a state of being covered by a sheath. Similarly, a plurality of second wires 24 may be bundled by being twisted together or covered with a sheath. The first wire 22 and the second wire 24 may also include a coaxial cable.

### Regarding Wire Movable Path Regulating Component

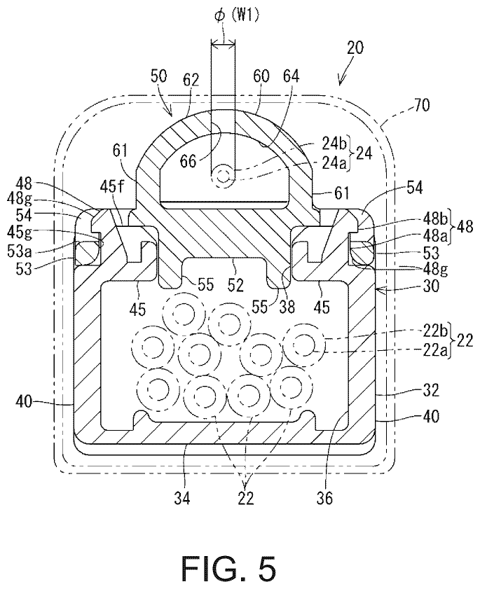

The wire movable path regulating component 30 will now be described. FIG. 4 is an exploded perspective view showing the wire movable path regulating component 30. FIG. 5 is a cross-sectional view taken along line V-V in FIG. 2 showing the wire movable path regulating component 30.

The wire movable path regulating component 30 is provided with a main body component 32 (main body) and a cover component 50 (cover). The main body component 32 and the cover component 50 are, for example, components that are separately molded from resin.

The main body component 32 is coupled in a rotationally movable manner to the main body component 32 of another wire movable path regulating component 30. The main body component 32 has a housing opening 38 and the first wire housing space 36. The housing opening 38 is an opening through which the first wire 22 is housed within the main body component 32. The first wire housing space 36 is a space for housing the first wire 22 in a state of passing therethrough inside the housing opening 38.

More specifically, the main body component 32 is a component integrally molded from resin and is provided with a bottom piece 34 and a pair of side pieces 40.

The side pieces 40 are formed in an elongated plate shape. A coupling recessed part 41 is formed at one longitudinal end portion of each side piece 40. In the present embodiment, the coupling recessed part 41 is a round through hole. The outer peripheral edge of the one longitudinal end portion of each side piece 40 is formed as an arc-shaped edge 42 that projects outward.

A coupling protruding part 44 is formed on the outward-facing surface of the other longitudinal end portion of each side piece 40. In the present embodiment, the coupling protruding part 44 is a short cylindrical protrusion. The coupling protruding parts 44 of the other longitudinal end portions of the pair of side pieces 40 are fitted into the coupling recessed parts 41 of the one longitudinal end portions of another pair of side pieces 40. A plurality of adjacent main body components 32 are thereby coupled in such a manner as to be rotationally movable about a central axis of the pair of coupling protruding parts 44.

A portion of the distal end surface of the coupling protruding part 44 toward the other longitudinal end portion of each side piece 40 is formed as a guide surface 44g that reduces the protruding length proceeding toward the other longitudinal end portion of the side piece 40. The one end portion of each side piece 40 can thus readily ride up onto the coupling protruding part 44 of another side piece 40, utilizing the guide surface 44g of the coupling protruding part 44. The coupling protruding part 44 can thereby be readily fitted into the coupling recessed part 41.

The outward-facing surface of the other longitudinal end portion of each side piece 40 is more recessed than the outward-facing surface of the one longitudinal end portion of the side piece 40. The difference in level between outer surface of the one end portion of one side piece 40 and the outer surface of one end portion of another side piece 40 can thereby be reduced, in a state where the other end portion of the one side piece 40 is overlapped with the outer surface of the one end portion of the other side piece 40.

The outer peripheral edge of the other longitudinal end portion of each side piece 40 is formed in a shape that regulates the rotational movement range relative to another side piece 40. In the present embodiment, the outer peripheral edge of the other longitudinal end portion of the side piece 40 has a first regulating edge 46a that extends in the longitudinal direction of the side piece 40 and a second regulating edge 46b that inclines relative to the longitudinal direction of the side piece 40. The first regulating edge 46a and the second regulating edge 46b face in opposite directions to each other.

Two side pieces 40 are coupled together as a result of the coupling protruding part 44 being fitted into the coupling recessed part 41. In a state where the two side pieces 40 extend in a straight line, the first regulating edge 46a of one side piece 40 contacts an inward-facing protruding part 45 of the other side piece 40 (state indicated by a solid line in FIG. 3). In a state where the two side pieces 40 have rotationally moved relative to each other, the second regulating edge 46b of the one side piece 40 contacts the bottom piece 34 of the other side piece 40 (state indicated by a two-dot chain line in FIG. 3). The rotational movement range of the two side pieces 40 is thus restricted to the range over which the two regulating edges 46a and 46b of the one side piece 40 contact the inward-facing protruding part 45 or the bottom piece 34 of the other side piece 40.

The shapes of the first regulating edge 46a and the second regulating edge 46b are set as appropriate, according to the rotational movement range required between adjacent side pieces 40.

The bottom piece 34 is coupled to one side edge of each of the pair of side pieces 40. The first wire housing space 36 is the space enclosed by the bottom piece 34 and the pair of side pieces 40. The first wire housing space 36 is open on both longitudinal sides of the side pieces 40. The direction in which the first wire 22 passes through the two openings of the first wire housing space 36 is a through direction of the first wire housing space 36. This through direction coincides with the longitudinal direction of the side pieces 40. The first wire 22 can be housed in a state of passing through the first wire housing space 36 in such as manner as to extend on both longitudinal sides of the side pieces 40. The first wire housing space 36 is also open on the opposite side to the bottom piece 34. This opening is the housing opening 38 through which the first wire 22 is housed. The first wire housing space 36 is located on the bottom piece 34 side of the housing opening 38, that is, inside the housing opening 38. The first wire 22 is housed in a state of passing through the first wire housing space 36 via the housing opening 38.

The inward-facing protruding part 45 protruding toward the widthwise center of the pair of side pieces 40 is formed on the other side edge of each of the pair of side pieces 40. The inward-facing protruding part 45 is formed in a longitudinally intermediate portion of the other side edge of each of the pair of side pieces 40. There is a gap between distal end portions of the pair of inward-facing protruding parts 45. The gap is set to a size that allows the first wire 22 to pass through.

The first regulating edges 46a are able to contact the inward-facing protruding parts 45. The surfaces of the inward-facing protruding parts 45 on the opposite side to the bottom piece 34 are formed on support surfaces 45f that extend in the longitudinal direction of the side pieces 40 and in a direction orthogonal to the side pieces 40. The cover component 50 is stably supported on the support surfaces 45f.

The main body component 32 has a lock protruding part 48 as a locking part located on both side portions of the housing opening 38. Here, a long hole part 45g is formed in the longitudinal direction of each side piece 40 in a longitudinally intermediate portion of the inward-facing protruding part 45. The lock protruding part 48 serving as a locking part protrudes through the hole part 45g from the other side edge of the side piece 40. The lock protruding part 48 has a plate part 48a that protrudes outward in the width direction of the side piece 40 and a protruding part 48b that protrudes in the thickness direction of the plate part 48a from a distal end portion of the plate part 48a. The plate part 48a is formed at an interval to the inner peripheral surface of the hole part 45g and can elastically deform within the hole part 45g. The protruding parts 48b protrude outward of the pair of side pieces 40. The distal end portion of each protruding part 48b is formed as a guide surface 48g that gradually decreases in height toward the distal end portion of the plate part 48a.

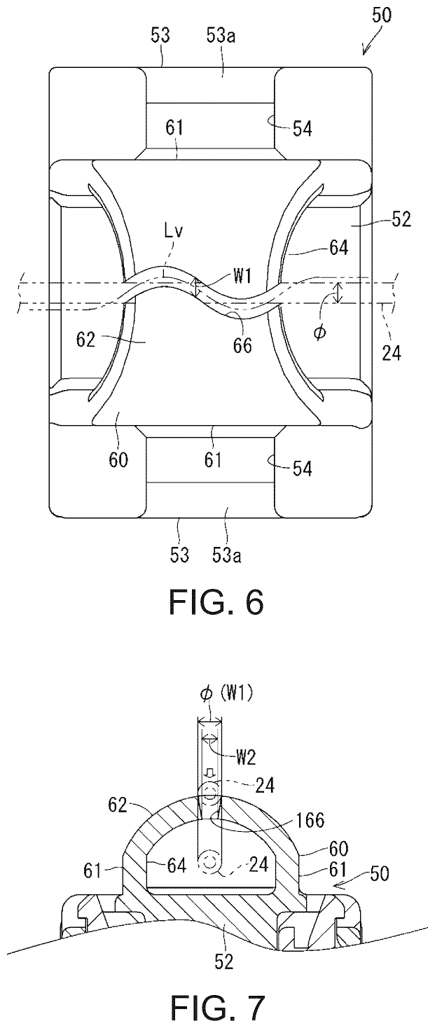

FIG. 6 is a plan view showing the cover component 50. As shown in FIGS. 2 to 6, the cover component 50 is integrally molded from resin, separately from the main body component 32. The cover component 50 has a cover main body part 52 (cover main body) and an additional enclosing part 60.

The cover main body part 52 includes a plate-shaped portion that blocks the housing opening 38. The cover main body part 52 is not required to block the entirety of the housing opening 38 and need only block the housing opening 38 to the extent that the first wire 22 is prevented from coming out through the housing opening 38. In the present embodiment, the cover main body part 52 blocks the portion of the housing opening 38 where the inward-facing protruding parts 45 are provided.

More specifically, the cover main body part 52 includes a rectangular plate-shaped portion. The width of the cover main body part 52 is set to be larger than the interval between the pair of side pieces 40. The length of the cover main body part 52 is set to be long enough to be able to cover the inward-facing protruding parts 45. The cover main body part 52 is able to cover the housing opening 38, when placed on the support surfaces 45f of the pair of inward-facing protruding parts 45.

The cover main body part 52 has a positioning auxiliary protruding part 53 that extends over the outward-facing surface of the other side edge of each of the pair of side pieces 40. Positioning of the cover main body part 52 in the width direction is performed as a result of the pair of positioning auxiliary protruding parts 53 contacting the outward-facing surfaces of the pair of side pieces 40 in a state where the cover main body part 52 is blocking the housing opening 38.

The cover main body part 52 has locking hole parts 54 as lock-receiving parts that the lock protruding parts 48 latch to. In the present embodiment, the locking hole parts 54 are formed in corner portions of the cover main body part 52 that extend from the portions that are placed on the support surfaces 45f to the positioning auxiliary protruding parts 53. Edge portions 53a of the locking hole parts 54 formed in the positioning auxiliary protruding parts 53 face in the protruding direction of the lock protruding parts 48. The cover main body part 52 is thus locked so as to not separate from the other side edges of the side pieces 40, as a result of the protruding parts 48b of the lock protruding parts 48 latching to the edge portions 53a.

The locking hole parts 54 also extend to the portions of the cover main body part 52 that are placed on the support surfaces 45f. The lock protruding parts 48 are able to elastically deform in the thickness direction of the plate parts 48a, utilizing the portions of the locking hole parts 54 that extend over the support surfaces 45f.

The cover component 50 is attached to the main body component 32, as a result of the pair of lock protruding parts 48 latching to the pair of locking hole parts 54 in a retained manner. Note that locking hole parts may be formed in the main body component, and lock protruding parts may be formed on the cover component.

The cover main body part 52 has a pair of auxiliary pieces 55 that extend toward the bottom piece 34, inward of the distal end portions of the inward-facing protruding parts 45. Looseness of the cover main body part 52 with respect to the main body component 32 is suppressed, as a result of the pair of auxiliary pieces 55 contacting the distal end portions of the inward-facing protruding parts 45, in a state where the cover component 50 is attached to the main body component 32.

The additional enclosing part 60 is a portion that forms the second wire housing space 64 for housing the second wire 24 in a state of passing therethrough. The second wire housing space 64 is a space partitioned from the first wire housing space 36 by the cover main body part 52.

In the present embodiment, the additional enclosing part 60 has a pair of base end portions 61 and an enclosing main body part 62.

The pair of base end portions 61 are located inward of the pair of locking hole parts 54. The pair of base end portions 61 have a long plate shape in the longitudinal direction of the side pieces 40 and protrude on the opposite side to the main body component 32 with respect to the cover main body part 52.

The enclosing main body part 62 joins the distal end portions of the pair of base end portions 61 at a position spaced away from the cover main body part 52. In the present embodiment, the enclosing main body part 62 is formed in a plate shape that describes an arc projecting on the opposite side to the bottom piece 34, as viewed in the longitudinal direction of the side pieces 40. Therefore, in the present embodiment, the additional enclosing part 60 has a U-shape in which the pair of base end portions 61 are continuous with both end portions of the enclosing main body part 62, as viewed in the longitudinal direction of the side pieces 40.

Since the pair of base end portions 61 are located inward of the pair of locking hole parts 54 and the enclosing main body part 62 is coupled to the pair of base end portions 61, the additional enclosing part 60 as a whole is located inward of the pair of locking hole parts 54.

Note that it is not essential for the enclosing main body part 62 to have a U-shape as viewed in the longitudinal direction of the side pieces 40. The enclosing main body part 62 may be continuous with the pair of base end portions 61 at an angle such as a right angle. The enclosing main body part 62 may also have a flat plate shape or V plate shape.

The space enclosed by the cover main body part 52, the pair of base end portions 61, and the cover main body part 52 is the second wire housing space 64 that houses the second wire 24. The second wire housing space 64 is open on both sides in the longitudinal direction of the side pieces 40. The through direction of the second wire housing space 64 coincides with the longitudinal direction of the side pieces 40. The second wire 24 is housed within the second wire housing space 64 in a state of passing therethrough in the longitudinal direction of the side pieces 40. The second wire housing space 64 is partitioned from the first wire housing space 36 by the cover main body part 52.

The first wire 22 is thus housed within the first wire housing space 36, and, separately thereto, the second wire 24 is housed within the second wire housing space 64. The first wire 22 is inhibited from entering the second wire housing space 64 and the second wire 24 is inhibited from entering the first wire housing space 36.

As described above, there are envisaged to be fewer second wires 24 than first wires 22. The second wire housing space 64 may thus be smaller than the first wire housing space 36, as viewed in the longitudinal direction of the first wire 22 and the second wire 24. The smaller number of second wires 24 can thereby be housed inside a smaller space, and the larger number of first wires 22 can be housed inside a larger housing space.

A wire housing slit 66 is formed in the additional enclosing part 60. The wire housing slit 66 is a slit that extends from an opening edge 64a on one side of the second wire housing space 64 to an opening edge 64b on the other side thereof in the through direction of the second wire housing space 64. The inner side of the wire housing slit 66 is open on the second wire housing space 64 side, and the outer side of the wire housing slit 66 is open on the outer side of the additional enclosing part 60. The second wire 24 is thus housed within the second wire housing space 64, by disposing the second wire 24 so as to be aligned with the wire housing slit 66 and pushing the second wire 24 into the wire housing slit 66, from the outer side of the additional enclosing part 60.

In the present embodiment, the wire housing slit 66 includes a bent portion 66v that bends between the opening edge 64a on the one side and the opening edge 64b on the other side. Here, the bent portion 66v bends so as to describe a curve. More specifically, the wire housing slit 66 extends in a bent manner so as to describe a sine curve. In the present embodiment, the wire housing slit 66 extends so as to describe a sine curve that repeats an S-shape every cycle, and includes two bent portions 66v. The number of S-shapes repeated by the wire housing slit 66 is not particularly limited, and the number of bent portions 66v is not particularly limited. The wire housing slit 66 preferably has at least one bent portion 66v. The bent portion 66v is preferably a portion that bends so as to describe a curve but this configuration is not essential. The bent portion may be a portion that bends at an angle.

When the wire housing slit 66 includes the bent portion 66v, the second wire 24 is unlikely to come out from the second wire housing space 64 through the wire housing slit 66.

The width of the wire housing slit 66 need only be wide enough to enable the second wire 24 to be inserted. When expansion of the width of the wire housing slit 66 due to deformation of the additional enclosing part 60 can be expected, it will not be an issue even if the width of the wire housing slit 66 is smaller than the diameter of the second wire 24. When not much expansion of the width of the wire housing slit 66 due to deformation of the additional enclosing part 60 can be expected, the width of the wire housing slit 66 is preferably the same as the diameter of the second wire 24 or larger than the diameter thereof.

In the present embodiment, an outer width W1 of the wire housing slit 66 is greater than or equal to a diameter φ of the second wire 24. For example, the outer width W1 of the wire housing slit 66 is the same as the diameter φ of the second wire 24. In the case where second wires 24 of different diameters are housed in the second wire housing space 64, the largest diameter thereof may be taken as the diameter φ of the second wire 24.

If the outer width W1 of the wire housing slit 66 is greater than or equal to the diameter φ of the second wire 24, it is easy to push the second wire 24 into the outer portion of the wire housing slit 66 from the outer side the additional enclosing part 60.

Also, in the present embodiment, the overall width of the wire housing slit 66 is greater than or equal to the diameter φ of the second wire 24. The overall width of the wire housing slit 66 is the width of the wire housing slit 66 at all positions in the direction in which the wire housing slit 66 extends, and the width at all positions on the outer and inner sides of the wire housing slit 66 and an intermediate portion thereof. For example, the overall width of the wire housing slit 66 is the same as the diameter φ of the second wire 24. In the case where second wire 24 of different diameters are housed in the second wire housing space 64, the largest diameter thereof may be taken as the diameter φ of the second wire 24, as described above.

If the overall width of the wire housing slit 66 is greater than or equal to the diameter φ of the second wire 24, the second wire 24 is able to readily pass through the wire housing slit 66, even if deformation of the additional enclosing part 60 is difficult to expect.

As with a modification shown in FIG. 7, a minimum width W2 of a wire housing slit 166 that corresponds to the wire housing slit 66 may be smaller than the diameter φ of the second wire 24. Here, the outer width W1 of the wire housing slit 166 is greater than or equal to the diameter φ. The wire housing slit 166 gradually narrows toward the second wire housing space 64, and the inner width W2 on the second wire housing space 64 side is smaller than the diameter φ.

In this case, it is thought that, as a result of the second wire 24 being pushed into the wire housing slit 166, the additional enclosing part 60 elastically deforms and the wire housing slit 166 is pushed open, allowing the second wire 24 to move toward the second wire housing space 64. It is thought that, after the second wire 24 has passed through the wire housing slit 166, the additional enclosing part 60 returns to its original shape, and the inner width W2, which is the minimum width of the wire housing slit 166, becomes smaller than the second wire 24. It is thus difficult for the second wire 24 to come out through the wire housing slit 166.

The wire housing slit 66 is formed in the widthwise center of the cover component 50. In the present embodiment, the amplitude center of the sine curve described by the wire housing slit 66 is located in the widthwise center of the cover component 50. Thus, even if, in the case where a plurality of wire movable path regulating components 30 are coupled together in alignment, the orientation of the cover component 50 is changed left to right, the wire housing slit 66 itself will be located in the widthwise center of each wire movable path regulating component 30. The second wire 24 can be thus continuously inserted into the wire housing slits 66 sequentially in the widthwise center of the wire movable path regulating components 30.

The position of the wire housing slit 66 in the additional enclosing part 60 is, of course, not particularly limited. For example, the wire housing slit 66 may be formed closer to either one of the base end portions 61.

The enclosing main body part 62, which is a portion of the additional enclosing part 60 on the opposite side to the main body component 32 as described above, is formed in an arc shape projecting outward as viewed in the through direction of the second wire housing space 64. The height of a widthwise center portion of the second wire housing space 64 is thus greater than both sides thereof. The length of the additional enclosing part 60 in the through direction of

the second wire housing space 64 is formed so as to gradually decreases proceeding away from the main body component 32. In the present embodiment, the pair of base end portions 61 are formed so as to gradually narrow in width proceeding away from the cover main body part 52. The enclosing main body part 62 is also formed so as to gradually decrease in length proceeding away from the cover main body part 52. Thus, when the additional enclosing part 60 is viewed in the width direction of the cover main body part 52, the additional enclosing part 60 has a trapezoidal shape that gradually narrows in width proceeding away from the cover main body part 52.

When adjacent wire movable path regulating components 30 are rotationally moved in a direction that brings the enclosing main body parts 62 closer together, adjacent enclosing main body parts 62 are thus less likely to interfere with each other. A large rotational movement range can thereby be set for the adjacent wire movable path regulating components 30.

The material of the main body component 32 and the cover component 50 is not particularly limited. For example, the main body component 32 and the cover component 50 may be made of a fiber reinforced resin. Fiber reinforced resin is a resin reinforced by fibers such as glass fibers or carbon fibers. The resin compounded with fibers is, for example, polyamide 66 (PA66). In this case, the entirety of the wire movable path regulating component 30 can be made high strength.

The main body component 32 may be more rigid than the cover component 50. Here, which of two components is more rigid (or more flexible) may be evaluated using values obtained by a hardness test according to ISO/TS 19278:2019, for example. For example, the main body component 32 may be made of polyamide 66 (PA66) and the cover component 50 may be made of polypropylene (PP). The main body component 32 may contain glass fibers.

If the main body component 32 is rigid, the wire movable path regulating components 30 are unlikely to uncouple from each other, and the rotational movement range between the wire movable path regulating components 30 is tightly regulated. The path of the path regulating wire harness 20 is thus tightly regulated. The task of housing the second wire 24 can then be readily performed by opening the wire housing slit 66, utilizing the flexibly of the cover component 50.

The cover component 50 has regulating shape plane symmetry with respect to a surface orthogonal to the width direction thereof. In other words, the pair of positioning auxiliary protruding parts 53 and the pair of locking hole parts 54 of the cover main body part 52 are formed in a bilaterally symmetrical shape in the width direction. The additional enclosing part 60 is also formed in a bilaterally symmetrical shape. Also, the cover component 50 has regulating shape plane symmetry with respect to a surface orthogonal to the through direction of the second wire housing space 64. In other words, the pair of positioning auxiliary protruding parts 53 and the pair of locking hole parts 54 of the cover main body part 52 are formed in a symmetrical shape in the front-back direction, which is the through direction of the second wire housing space 64. The additional enclosing part 60 is also formed in a symmetrical shape in the front-back direction.

Thus, even if the attachment orientation of the cover component 50 to the main body component 32 is changed left to right, the combined shape of the main body component 32 and the cover component 50 is the same. In other words, two postures are conceivable as attachment postures of the cover component 50 to the main body component 32, based on the combination of the pair of lock protruding parts 48 and the pair of locking hole parts 54. In either posture, the combined shape of the main body component 32 and the cover component 50 is the same.

Note that, here, regulating shape plane symmetry means having plane symmetry in relation to shapes for regulating the paths of the wires 22 and 24; that is, the cover component 50 has plane symmetry in relation to functional portions that relate to regulating the paths of the first wire 22 and the second wire 24, and regulating the range over which the wire movable path regulating component 30 rotationally moves. Thus, for example, shape portions that are for housing the second wire 24 and do not affect regulation of the path regulation range and the rotational movement range, such as the wire housing slit 66, need not have such plane symmetry. The cover component 50 need also not have plane symmetry in relation to design-related shape portions thereof that do not affect the above functions.

If the cover component 50 has regulating shape plane symmetry with respect to a surface orthogonal to the width direction thereof, the cover component 50 can be attached to the main body component 32 without worrying about the orientation.

The path regulating wire harness 20 is manufactured as follows, for example.

First, a plurality of wire movable path regulating components 30 are coupled together in a row. In this state, the first wire housing spaces 36 of the wire movable path regulating components 30 are disposed so as to be aligned in a row. Also, the first wire housing spaces 36 are open via the housing openings 38. The housing openings 38 are also aligned in a row.

The first wire 22 is disposed between the pairs of side pieces 40 through the housing openings 38. Next, pairs of lock protruding parts 48 are inserted into the pairs of locking hole parts 54, and the protruding parts 48b are latched to the locking hole parts 54. The cover components 50 are thereby attached to the main body components 32, in a state where the cover main body parts 52 block the housing openings 38. In this state, the first wire 22 is kept in a state of being housed within the first wire housing spaces 36 aligned in a row.

In the state after the attachment of the cover components 50, a plurality of second wire housing spaces 64 are also disposed so as to be aligned in a row, on the outer side of the cover main body part 52. The second wire 24 is sequentially pushed into the plurality of wire housing slits 66 aligned in a row. At this time, the second wire 24 is disposed within the outer opening of the wire housing slit 66, as a result of being bent into a shape that corresponds to the bent portion 66v of the wire housing slit 66 (see two-dot chain line Lv in FIG. 6). As a result of the second wire 24 being pushed further in, the second wire 24 passes through the wire housing slit 66 and enters the second wire housing space 64. The second wire 24 is thereby housed within the second wire housing space 64.

In a state where the second wire 24 is housed within the second wire housing space 64, the second wire 24 extends in a straighter line than the bent shape adopted when passing through the wire housing slit 66. The second wire 24 is thus inhibited from coming out through the wire housing slit 66 having the bent portion 66v.

As described above, the second wire 24 is housed within the second wire housing space 64 through the wire housing slit 66. Thus, the second wire 24 does not need to be passed through the second wire housing spaces 64. The task of holding the second wire 24 can thereby be readily performed.

Note that the plurality of wire movable path regulating components 30 coupled together in a row may be covered by an exterior member 70 formed in a cylindrical shape and made of rubber or the like (see FIGS. 1 and 5). The exterior member may, for example, also be a member known as a rubber boot.

### Operations of Path Regulating Wire Harness

Example operations of the path regulating wire harness 20 will now be described.

The path regulating wire harness 20 is arranged so as to extend between the vehicle body main body 10 and the sliding door 14. In this state, the wire movable path regulating component 30 at one end of the plurality of wire movable path regulating components 30 coupled together in a row is coupled to the vehicle body main body 10. The wire movable path regulating component 30 at the other end of the plurality of wire movable path regulating components 30 is coupled to the sliding door 14. The plurality of wire movable path regulating components 30 thereby move so as to bend following the opening and closing operation of the sliding door 14. Between adjacent wire movable path regulating components 30, the pairs of coupling protruding parts 44 are regulated to rotationally moving about the axis thereof. Also, the rotational movement range of adjacent wire movable path regulating components 30 is regulated by the shapes of the first regulating edges 46a and the second regulating edges 46b. The path of the plurality of wire movable path regulating components 30 is thus regulated so as to bend in a bending form determined in advance.

The first wire 22 and the second wire 24 are able to bend while the paths thereof are regulated by the plurality of wire movable path regulating components 30 with opening and closing of the sliding door 14. At this time, the path of the first wire 22 is regulated by the plurality of first wire housing spaces 36 that are arranged successively in a row. The path of the second wire 24 is regulated by the plurality of second wire housing spaces 64 that are arranged successively in a row next to the first wire 22.

Supposing that the first wire housing space 36 and the second wire housing space 64 were continuous with each other, the first wire 22 could possibly move to the second wire housing space 64 side, and the second wire 24 could possibly move to the first wire housing space 36 side. In that case, the degree of freedom in the positions of the first wire 22 and the second wire 24 in the wire movable path regulating component 30 increases. This leads to instability such as the first wire 22 being located on the outer peripheral side or the second wire 24 is located on the inner peripheral side, in a state where the path regulating wire harness 20 is bent. As such, the path lengths of the first wire 22 and the second wire 24 could possibly change greatly in response to changes in the path of the path regulating wire harness 20.

In the present embodiment, the path of the first wire 22 is regulated by the first wire housing space 36, and the path of the second wire 24 is regulated by the second wire housing space 64 next to the first wire 22. Therefore, the paths of the first wire 22 and the second wire 24 are regulated in limited areas, compared to the case where the first wire housing space 36 and the second wire housing space 64 are continuous with each other. Changes in the path lengths of the first wire 22 and the second wire 24 due to changes in the path of the path regulating wire harness 20 can thus be reduced.

The required lengths of the first wire 22 and the second wire 24 are thus easy to predict. The ways in which the first wire 22 and the second wire 24 will bend inside the path regulating wire harness 20 are also easy to predict. The bending capacity of the first wire 22 and the second wire 24 is thus easy to predict. Note that the bending capacity can be evaluated by the number of bends or the like until the first wire 22 and the second wire 24 break, in the case where repeated bending is performed under the condition that the path is regulated by the wire movable path regulating components 30.

### Utilization Example

The path regulating wire harness 20 can, for example, be utilized in situations such as the following.

For example, assume that, in the basic design, a path regulating wire harness that includes at least one first wire 22 and does not include a second wire 24 is designed. The basic design is, for example, a design relating to an initial model of a vehicle. In the basic design, an electrical component incorporated into the sliding door 14 is set. As a path regulating wire harness that corresponds to the basic design, path design for regulating bending of the path of the first wire 22 connected to the electrical component incorporated in the sliding door 14 is carried out. This path regulating wire harness employs a wire movable path regulating component that omits the additional enclosing part 60 of the path regulating wire harness 20.

Assume that, thereafter, additional design for adding an electrical component to the sliding door 14 is carried out. In this case, path regulation will be performed with the addition of the second wire 24 that is connected to the additional electrical component. The first wire housing space 36 is designed to regulate the path of the first wire 22 in the basic design. Thus, there could possibly be no space left in the first wire housing space 36 for housing the second wire 24. Also, if the second wire 24 is added to the first wire housing space 36, the behavior of the first wire 22 in the first wire housing space 36 will change, and the bending capacity of the first wire 22 could possibly change.

In view of this, as described above, the cover component 50 to which the additional enclosing part 60 is added is set. The cover component 50 having the additional enclosing part 60 is attached to the main body component 32, instead of the cover component employed in the basic design. The main body component 32 is the same as the main body component 32 in the basic design.

In this case, the path of the first wire 22 is regulated in a similar manner to the basic design. Thus, the bending capacity of the second wire 24 need only be predicted. Since the path of the second wire 24 is regulated within the second wire housing space 64 partitioned from the first wire housing space 36, the bending behavior of the second wire 24 is stable, and there is also little fluctuation in path length following bending. The bending capacity due to addition the second wire 24 can thus be readily predicted.

### Effects and Related Matters

According to the wire movable path regulating component 30 and the path regulating wire harness 20 constituted as described above, even if the second wire 24 is added to a path regulating wire harness that is based on a basic design, the path of the first wire 22 is regulated within the first wire housing space 36 that is based on the basic design. Addition of the second wire 24 is thus unlikely to affect the movement of the first wire 22. Also, the path of the second wire 24 is regulated within the second wire housing space 64 partitioned from the first wire housing space 36. Since the path of the first wire 22 is regulated within the first wire housing space 36 and the path of the second wire 24 is regulated within the second wire housing space 64, the ranges of the first wire 22 and the second wire 24 at the time of changing the paths are limited. Changes in the path lengths of the first wire 22 and the second wire 24 in response to changes in the paths thereof are thus reduced. Variation in the loads acting on the first wire 22 and the second wire 24 when the paths of the first wire 22 and the second wire 24 change is thereby reduced. As a result, the bending capacities of the first wire 22 and the second wire 24 are readily predicted.

Also, because the mold of the main body component 32 for the basic design can be used, it is not necessary to make a new mold. Design is also facilitated because the enclosing part 60 need only be added to the shape of the cover main body part 52 for the basic design.

Also, since the wire housing slit 66 is formed in the additional enclosing part 60, the second wire 24 does not need to be initially passed through the second wire housing space 64. The task of holding the second wire 24 is thereby facilitated. Also, tasks such as attaching a connector to the second wire 24 in advance and bundling a plurality of second wires can be performed beforehand. In the state before the second wire 24 is held by the wire movable path regulating component 30, the task of provisionally bundling a plurality of second wires automatically using automated equipment is also facilitated.

Also, since the cover component 50 can be constituted as one component, a configuration that is able to readily house the second wire 24 can be realized while reducing the number of components.

Also, supposing that a cover openable and closable by a thin hinge is provided in order to be able to house the second wire in the cover component, utilizing a rigid resin becomes difficult since the thin hinge is elastically deformed. In the present embodiment, the cover component 50 is not required to have a high degree of flexibility, thus enabling the cover component 50 to also be made of a rigid resin.

In particular, the main body component 32 and the cover component 50 can be made of a reinforced resin. It thereby becomes possible to secure the strength of the wire movable path regulating component with the main body component and cover component made of a fiber reinforced resin.

Also, the wire housing slit 66 includes the bent portion 66v that bends between the opening edges 64a and 64b. By bending the second wire 24 in correspondence with the bent portion 66v, the second wire 24 is thus disposed within the second wire housing space 64 through the wire housing slit 66. The second wire 24 within the second wire housing space 64 interferes with the bent portion 66v and is thus unlikely to come out from the second wire housing space 64. For example, even if the wire housing slit 66 is greater than or equal to the diameter φ of the second wire 24, the second wire 24 is unlikely to come out from the second wire housing space 64.

Also, the bent portion 66v bends so as to describe a curve. Thus, even if the second wire 24 contacts the edge portions that bend in correspondence with the bent portion 66v on both sides of the wire housing slit 66 when passing through the wire housing slit 66, the second wire 24 is inhibited from pushing against the edge portions with a strong force.

Also, since the outer width W1 of the wire housing slit 66 is greater than or equal to the diameter φ of the second wire 24, it is easy to push the second wire 24 into the outer portion of the wire housing slit 66. As long as the second wire 24 can be pushed into the outer portion of the wire housing slit 66, the second wire 24 is able to readily pass through the wire housing slit 66 and enter the second wire housing space 64 by being further pushed, even if the inner width of the wire housing slit 66 is narrow.

Also, if the overall width of the wire housing slit 66 is greater than or equal to the diameter φ of the second wire 24, it is easy to insert the second wire 24 into the wire housing slit 66. In particular, this configuration is effective in the case where the cover component 50 is made of a rigid resin, and it is difficult to greatly deform the additional enclosing part 60.

Also, if the wire housing slit 66 is formed in the widthwise center of the cover component 50, the wire housing slits 66 of a plurality of cover components 50 will be aligned in the widthwise center of the cover components 50, even if the left and right attachment postures of the plurality of cover components 50 differ. The task of continuously housing the second wire 24 in the second wire housing spaces 64 through the plurality of wire housing slits 66 is thus facilitated.

Also, the second wire 24 can be readily added as long as there are fewer second wires 24 than first wires 22. Also, the movable range of the added second wire 24 at the time of path regulation is limited, as a result of the second wire 24 being housed in the second wire housing space 64, which is smaller than the first wire housing space 36. The bending capacity of the second wire 24 is thereby readily predicted.

Also, since the additional enclosing part 60 is provided inward of the locking hole parts 54, the locking hole parts 54 can be readily molded without the additional enclosing part 60 getting in the way.

Also, the length of the additional enclosing part 60 in the front-back direction is set so as to gradually decrease proceeding away from the main body component 32. When the wire movable path regulating component 30 rotates relative to an adjacent wire movable path regulating component 30, the additional enclosing part 60 is thus unlikely to interfere with the adjacent additional enclosing part 60. It is thus easy to set a large rotational movement range for the adjacent wire movable path regulating components 30.

Also, the portion of the additional enclosing part 60 on the opposite side to the main body component 32 is formed in an arc shape. Thus, when covering the outer side of the plurality of wire movable path regulating components 30 arranged successively in a row with the exterior member 70, the additional enclosing part 60 is unlikely to catch on the exterior member 70, and it is easy to cover the wire movable path regulating components 30 with the exterior member 70. Also, it is easy to maintain the second wire 24 in the widthwise center of the additional enclosing part 60.

Note that the configurations described in the above embodiment and modifications can be combined as appropriate, provided there are no mutual inconsistencies.

1. A wire movable path regulating component for regulating a movable path of at least one first wire and at least one second wire that extend between a first component and a second component movable relative to the first component, comprising:
a main body component to be coupled in a rotationally movable manner to another wire movable path regulating component; and
a cover component that is a separate component from the main body component and is attached to the main body component,
wherein the main body component has a bottom piece and a pair of side pieces, one side piece of the pair being coupled to the other wire movable path regulating component in a rotationally movable manner and the other side piece of the pair being further coupled to the other wire movable path regulating component in a rotationally movable manner;
the main body component has a housing opening open on an opposite side to the bottom piece and through which the at least one first wire is housed and a first wire housing space for housing the at least one first wire in a state of passing therethrough inside the housing opening,
the cover component has a cover main body part that blocks the housing opening and an additional enclosing part forming a second wire housing space for housing the at least one second wire in a state of passing therethrough,
the second wire housing space is partitioned from the first wire housing space by the cover main body part, and
a wire housing slit extending from an opening edge on one side of the second wire housing space to an opening edge on another side thereof is formed in the additional enclosing part.

2. The wire movable path regulating component according to claim 1, wherein the main body component and the cover component are made of a fiber reinforced resin.

3. The wire movable path regulating component according to claim 1 or 2, wherein the wire housing slit includes a bent portion that bends between the opening edge on the one side of the second wire housing space and the opening edge on the other side thereof.

4. The wire movable path regulating component according to claim 3, wherein the bent portion bends so as to describe a curve, such that the wire housing slit bends in a curved S-shape.

5. The wire movable path regulating component according to any one of claims 1 to 4, wherein an outer width of the wire housing slit is greater than or equal to a diameter of the second wire.

6. The wire movable path regulating component according to any one of claims 1 to 5, wherein an overall width of the wire housing slit is greater than or equal to the diameter of the second wire.

7. The wire movable path regulating component according to any one of claims 1 to 5, wherein a minimum width of the wire housing slit is smaller than the diameter of the second wire.

8. The wire movable path regulating component according to any one of claims 1 to 7, wherein the wire housing slit is formed in a widthwise center of the cover component.

9. The wire movable path regulating component according to any one of claims 1 to 8,
wherein the main body component has a locking part located on both sides of the housing opening,
the cover main body part has a lock-receiving part to which the locking part latches, and
the additional enclosing part is located inward of the lock-receiving part.

10. The wire movable path regulating component according to any one of claims 1 to 9, wherein the at least one second wire housed within the second wire housing space is fewer in number than the at least one first wire housed within the first wire housing space.

11. The wire movable path regulating component according to any one of claims 1 to 10, wherein a length of the additional enclosing part in a through direction of the second wire housing space gradually decreases proceeding away from the main body component.

12. The wire movable path regulating component according to any one of claims 1 to 11, wherein a portion of the additional enclosing part on an opposite side to the main body component is formed in an arc shape as viewed in the through direction of the second wire housing space.

13. A path regulating wire harness comprising:
the wire movable path regulating component according to any one of claims 1 to 12;
the at least one first wire; and
the at least one second wire,
wherein the plurality of wire movable path regulating components are coupled together in a row in such a manner as to be rotationally movable relative to each other,
the at least one first wire is housed in the plurality of wire movable path regulating components in a state of passing through the first wire housing space, and
the at least one second wire is housed in the plurality of wire movable path regulating components in a state of passing through the second wire housing space.
